(19) United States
(12) Patent Application Publication
(10) Pub. No.: US 2011/0242824 A1
(43) Pub. Date: Oct. 6, 2011

(54) Conveniently Demountable Vertical Lamp

(76) Inventor: Ching-Hui CHEN, Huizhou City (CN)

(21) Appl. No.: 12/835,002

(22) Filed: Jul. 13, 2010

(30) Foreign Application Priority Data
Apr. 6, 2010 (CN) 201020174838.X

(51) Int. Cl. F21V 11/00

(52) U.S. Cl. 362/351

(57) ABSTRACT

The present invention discloses a conveniently demountable vertical lamp, which comprises a multilayer type frame body mainly composed of stand columns and clapboards; at least one layer of the multilayer type frame body is composed of a clapboard, several stand columns and non-lighttight lampshade sheets; the stand columns are respectively arranged at the perimeter of the clapboard; adjacent stand columns is provided with a non-lighttight lampshade sheet to connect, so as to use the clapboard, the stand columns and the non-lighttight lampshade sheets to together form a lampshade with a central non-lighttight chamber; a lamp is also arranged in the non-lighttight chamber of the lampshade. In this vertical lamp, for the multilayer type frame body is adopted and the lampshade is arranged at one layer of the multilayer type frame body, the vertical lamp not only has the lighting function as conventional lamps, but also the layers of the frame body below the lampshade also have the function of loading objects.

### FIELD OF THE INVENTION

The present invention involves the technical field of lamps, particularly involves a conveniently demountable vertical lamp.

### BACKGROUND OF THE INVENTION

The lamps in the market have all kinds of structures and types, such as ceiling lamp, flower lamp, pendant lamp, and wall lamp, which have attractive styles, and strong aesthetic appearance. However, the application range of the lamps of the above mentioned types is greatly limited by the factors such as their installation position and immovability. So, vertical lamps appear in the market, which have mobility and no need of being fixedly installed, thereby solving the disadvantages of traditional lamps. However, conventional vertical lamps still have the following disadvantages: (1) as the influence of the whole structure of conventional vertical lamps, they are not conveniently demountable, so, they are inconvenient for daily cleaning, storage and maintenance; furthermore, non conveniently demountable vertical lamps will also restrict the assembly efficiency at a certain degree, and at the same times, they are not convenient for transportation; (2) conventional vertical lamps generally just have the single function of lighting, but, vertical lamps themselves will have a certain volume, so, vertical lamps with the single function will obvious waste the space.

### SUMMARY OF THE INVENTION

An object of the present invention is aiming at the disadvantages of the conventional art to provide a vertical lamp, which is conveniently demountable, is convenient for daily cleaning, storage and maintenance, can improve the assembly efficiency and be convenient for transportation, and has multiple functions and strong aesthetic appearance.

The object of the present invention is achieved as the following.

A conveniently demountable vertical lamp comprises a multilayer type frame body mainly composed of stand columns and clapboards; at least one layer of the multilayer type frame body is composed of a clapboard, several stand columns and non-lighttight lampshade sheets; the stand columns are respectively arranged at the perimeter of the clapboard; adjacent stand columns is provided with a non-lighttight lampshade sheet to connect, so as to use the clapboard, the stand columns and the non-lighttight lampshade sheets to together form a lampshade with a central non-lighttight chamber; a lamp is also arranged in the non-lighttight chamber of the lampshade. In this vertical lamp, for the multilayer type frame body is adopted and the lampshade is arranged at one layer of the multilayer type frame body, the vertical lamp not only has the lighting function as conventional lamps, but also the layers of the frame body below the lampshade also have the function of loading objects. Moreover, for the structures between the clapboards, the stand columns and the non-lighttight lampshade sheets that form the frame body are conveniently demountable, this vertical lamp is convenient for daily cleaning, storage and maintenance, can improve the assembly efficiency and be convenient for transportation. Furthermore, by arranging figures, such as a pattern, on the non-lighttight lampshade sheet, the aesthetic appearance of the lamp can be greatly improved; especially when the lamp is lighting, the effect of aesthetic appearance is much better.

The object of the present invention can also adopt the following technical solutions to solve.

As a preferred embodiment, the lampshade is arranged at the top layer of the multilayer type frame body, so that the lighting area is wider and the lighting effect is better. The two or four side surfaces of the stand column where the lampshade is located at are respectively provided with a lampshade sheet limit groove along the height extension direction of the stand column. The two side edges of the non-lighttight lampshade sheet are respectively embedded into the lampshade sheet limit grooves of the corresponding surface of the stand columns at the two sides, so as to connect the stand columns at the adjacent two sides.

As a better improvement, the perimeter of the clapboard of the top layer of the multilayer type frame body is provided with lampshade sheet limit grooves. The downside edge of the non-lighttight lampshade sheet connecting the stand columns of the two sides is embedded into the corresponding lampshade sheet limit groove at the perimeter of the clapboard, so as to improve the integral fastness.

The clapboard of the top layer of the multilayer type frame body is quadrilateral. The four corner positions of the quadrilateral clapboard are respectively provided with a stand column. Four non-lighttight lampshade sheets in turn respectively connect the stand columns at the adjacent two sides.

The lamp is arranged on the clapboard in the central non-lighttight chamber.

The non-lighttight lampshade sheet is a thin non-lighttight sheet made of a semitransparent material, of which the outside surface is provided with a pattern layer. So, when the lamp is lighting, the effect of aesthetic appearance is much better.

As a preferred embodiment, the pattern layer of the non-lighttight lampshade sheet is made by injection molding, and the molded pattern layer is directly pasted to the outside surface of the non-lighttight lampshade sheet. Or, the pattern layer is made by directly being silkscreened on the outside surface of the non-lighttight lampshade sheet.

The peripheral edge of the clapboard of the top layer of the multilayer type frame body is provided with an outer frame. The stand column passes through the through hole at the corner position of the outer frame and is connected to the clapboard.

The upper part of the lampshade of the top layer of the multilayer type frame body is provided with a fixing frame, and screws are arranged between the fixing frame and the stand columns to fix them. The perimeter of the bottom of the fixing frame is also provided with lampshade sheet limit grooves for the upside edge of the non-lighttight lampshade sheets to be embedded into, so as to fix the upside edge of the non-lighttight lampshade sheets, which can further improve the fastness of the lampshade.

As a more specific structure, the multilayer type frame body is composed of four stand columns and multiple clapboards, and the multiple clapboards according to their height position divide the frame body into multiple layers. The other layers of the frame body can be used to store or load objects.

The advantages of the present invention are as the following.

In the vertical lamp of the present invention, for the multilayer type frame body is adopted and the lampshade is arranged at least one layer of the multilayer type frame body, the vertical lamp not only has the lighting function as conventional lamps, but also the layers of the frame body below the lampshade also have the function of loading objects. Moreover, for the structures between the clapboards, the stand columns and the non-lighttight lampshade sheets that form the frame body (lampshade) are conveniently demountable, this vertical lamp is convenient for daily cleaning, storage and maintenance, can improve the assembly efficiency and be convenient for transportation. Furthermore, by arranging figures, such as a pattern, on the non-lighttight lampshade sheet, the aesthetic appearance of the lamp can be greatly improved; especially when the lamp is lighting, the semitransparent non-lighttight lampshade sheets and the pattern layer arranged on the outside surface thereof make that the effect of aesthetic appearance is much better.

### BRIEF DESCRIPTION OF THE DRAWINGS

FIG. 1 is a stereo schematic diagram of a conveniently demountable vertical lamp of the present invention;

FIG. 2 is a schematic diagram of the vertical lamp of the present invention after the non-lighttight lampshade sheets at the top layer of the multilayer type frame body are removed;

FIG. 3 is an exploded schematic diagram of one side of the vertical lamp of FIG. 1;

FIG. 4 is a schematic diagram of a stand column of the vertical lamp of the present invention;

FIG. 5 is a schematic diagram of another embodiment of the stand column of FIG. 4.

### DESCRIPTION OF THE PREFERRED EMBODIMENT

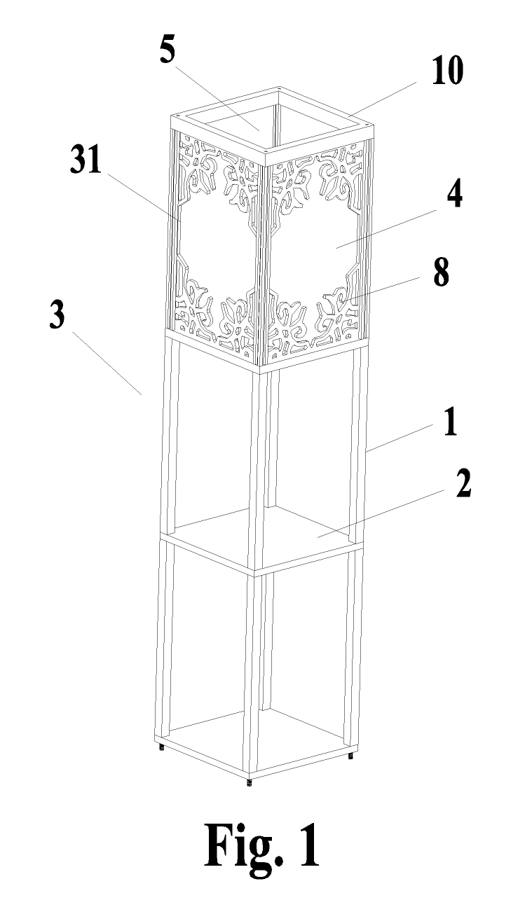

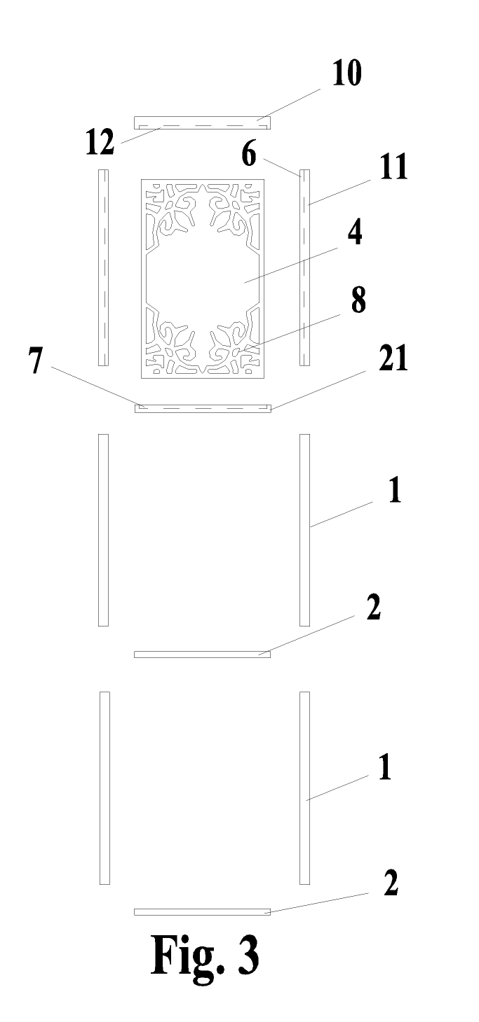

As shown in FIGS. 1-5, a conveniently demountable vertical lamp comprises a frame body 3 of multilayer type that is mainly composed of four stand columns 1 (each layer may independently be provided with four stand columns 1, as shown in FIG. 3) and multiple quadrilateral clapboards 2. The multiple quadrilateral clapboards 2 according to their height position divide the frame body 3 into multiple layers, so as to store and load objects between each adjacent two layers. Wherein, the top layer of the multilayer type frame body 3 is composed of a clapboard 21, four stand columns 11 and four non-lighttight lampshade sheets 4. The four stand columns 11 are respectively arranged at the four corner positions of the perimeter of the clapboard 21. Adjacent stand columns 11 are provided with a non-lighttight lampshade sheet 4 to connect, so as to use the clapboard 21, four stand columns 11 and four non-lighttight lampshade sheets 4 to together form a lampshade 31 with a central non-lighttight chamber 5. The clapboard 21 in the non-lighttight chamber 5 of the lampshade 31 is also provided with a lamp.

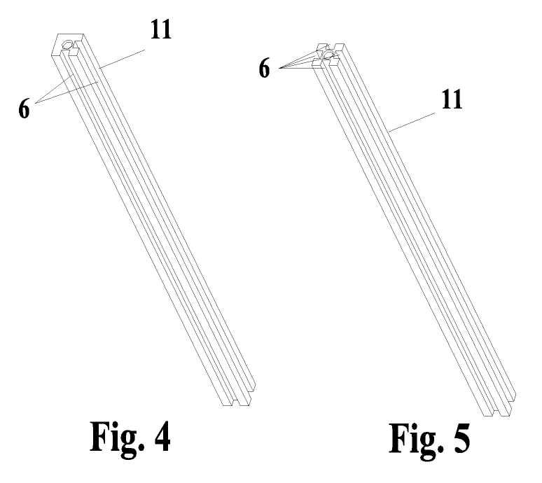

As shown in FIG. 4, the two side surfaces of the stand column 11 of the top layer of the multilayer type frame body 3 are respectively provided with a lampshade sheet limit groove 6 along the height extension direction of the stand column 11. The two side edges of the non-lighttight lampshade sheet 4 are respectively embedded into the lampshade sheet limit groove 6 of the corresponding surface of the stand columns 11 at the two sides, so as to connect the stand columns 11 at the adjacent two sides. Of course, the stand column 11 can also be as the embodiment shown in FIG. 5, that is: the four side surfaces of the stand column 11 are all respectively provided with a lampshade sheet limit groove 6 along the height extension direction of the stand column 11, so that while installing, the stand columns 11 can be connected to the non-lighttight lampshade sheet 4 without the need of adjusting the position relation of the side surfaces between adjacent stand columns 11.

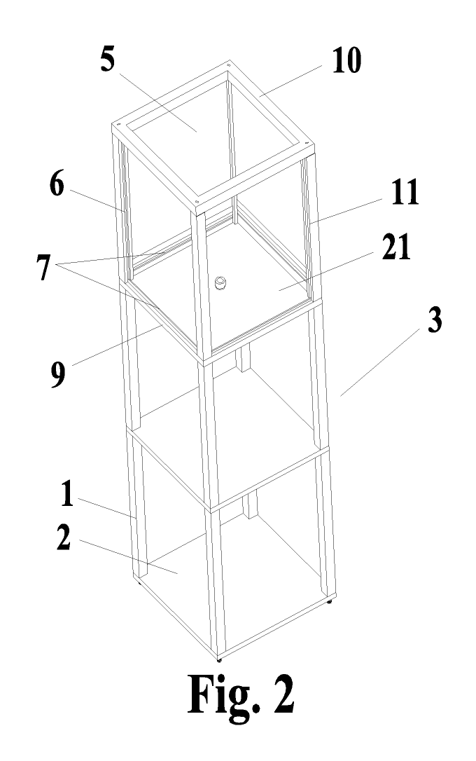

As shown in FIG. 2, the perimeter of the clapboard 21 of the top layer of the multilayer type frame body 3 is provided with lampshade sheet limit grooves 7. The downside edge of the non-lighttight lampshade sheet 4 connecting the stand columns 11 of the two sides is embedded into the corresponding lampshade sheet limit groove 7 at the perimeter of the clapboard 21. So, the edges of the left side, right side and downside of the non-lighttight lampshade sheet 4 are all embedded into the corresponding lampshade sheet limit grooves 6, 7, thereby improving the integral fastness. Such a lampshade sheet structure of limit groove type is easy and fast to be demounted.

The non-lighttight lampshade sheet 4 is a thin non-lighttight sheet made of a semitransparent material, of which the outside surface is provided with a pattern layer 8. The pattern layer 8 of the non-lighttight lampshade sheet 4 is made by injection molding, and the molded pattern layer 8 is directly pasted to the outside surface of the non-lighttight lampshade sheet 4. Or, the pattern layer 8 is made by directly being silkscreened on the outside surface of the non-lighttight lampshade sheet 4.

To improve the integral fastness, the peripheral edge of the clapboard 21 of the top layer of the multilayer type frame body 3 is provided with an outer frame 9. The stand column 11 passes through the through hole at the corner position of the outer frame 9 and is connected to the clapboard 21.

Furthermore, the upper part of the lampshade 31 of the top layer of the multilayer type frame body 3 is provided with a fixing frame 10, and screws are arranged between the fixing frame 10 and the stand column 11 to fix them, so that the integral frame body has better fastness. The perimeter of the bottom of the fixing frame 10 is also provided with lampshade sheet limit grooves 12 for the upside edge of the non-lighttight lampshade sheet 4 to be embedded into, so as to fix the upside edge of the non-lighttight lampshade sheet 4, thereby further improving the fastness of the lampshade 31.

What is claimed is:

1. A conveniently demountable vertical lamp comprising a multilayer type frame body mainly composed of stand columns and clapboards; at least one layer of the multilayer type frame body being composed of a clapboard, several stand columns and non-lighttight lampshade sheets; the stand columns are respectively arranged at the perimeter of the clapboard; adjacent stand columns being provided with a non-lighttight lampshade sheet to connect, so as to use the clapboard, the stand columns and the non-lighttight lampshade sheets to together form a lampshade with a central non-lighttight chamber; a lamp also being arranged in the non-lighttight chamber of the lampshade.

2. The conveniently demountable vertical lamp of claim 1, wherein the lampshade is arranged at the top layer of the multilayer type frame body; the two or four side surfaces of the stand column where the lampshade is located at are respectively provided with a lampshade sheet limit groove along the height extension direction of the stand column; the two side edges of the non-lighttight lampshade sheet are respectively embedded into the lampshade sheet limit grooves of the corresponding surface of the stand columns at the two sides, so as to connect the stand columns at the adjacent two sides.

3. The conveniently demountable vertical lamp of claim 2, wherein the perimeter of the clapboard of the top layer of the multilayer type frame body is provided with lampshade sheet limit grooves; the downside edge of the non-lighttight lampshade sheet connecting the stand columns of the two sides is embedded into the corresponding lampshade sheet limit groove at the perimeter of the clapboard.

4. The conveniently demountable vertical lamp of claim 2, wherein the clapboard of the top layer of the multilayer type frame body is quadrilateral; the four corner positions of the quadrilateral clapboard are respectively provided with a stand column; four non-lighttight lampshade sheets in turn respectively connect the stand columns at the adjacent two sides.

5. The conveniently demountable vertical lamp of claim 2, wherein the lamp is arranged on the clapboard in the central non-lighttight chamber.

6. The conveniently demountable vertical lamp of claim 2, wherein the non-lighttight lampshade sheet is a thin non-lighttight sheet made of a semitransparent material, of which the outside surface is provided with a pattern layer.

7. The conveniently demountable vertical lamp of claim 6, wherein the pattern layer of the non-lighttight lampshade sheet is made by injection molding, and the molded pattern layer is directly pasted to the outside surface of the non-lighttight lampshade sheet; or, the pattern layer is made by directly being silkscreened on the outside surface of the non-lighttight lampshade sheet.

8. The conveniently demountable vertical lamp of claim 2, wherein the peripheral edge of the clapboard of the top layer of the multilayer type frame body is provided with an outer frame; the stand column passes through the through hole at the corner position of the outer frame and is connected to the clapboard.

9. The conveniently demountable vertical lamp of claim 2, wherein the upper part of the lampshade of the top layer of the multilayer type frame body is provided with a fixing frame, and screws are arranged between the fixing frame and the stand columns to fix them; the perimeter of the bottom of the fixing frame is also provided with lampshade sheet limit grooves for the upside edge of the non-lighttight lampshade sheets to be embedded into, so as to fix the upside edge of the non-lighttight lampshade sheets.

10. The conveniently demountable vertical lamp of claim 1, wherein the multilayer type frame body is composed of four stand columns and multiple clapboards; the multiple clapboards according to their height position divide the frame body into multiple layers.
